(19) United States
(12) Patent Application Publication
(10) Pub. No.: US 2010/0112142 A1
(43) Pub. Date: May 6, 2010

(54) CONFECTIONERY PRODUCTS COMPRISING POLYOLS

(75) Inventors: David G. Barkalow, Deerfield, IL (US); Michael A. Reed, Merrillville, IN (US)

Correspondence Address: K&L Gates LLP, P.O. Box 1135, CHICAGO, IL, 60690, US

(73) Assignee: WM. WRIGLEY JR. COMPANY, Chicago, IL (US)

(21) Appl. No.: 12/526,919

(22) PCT Filed: Feb. 11, 2008
(86) PCT No.: PCT/US08/53583

§ 371 Date: Jan. 8, 2010

Related U.S. Application Data
(60) Provisional application No. 60/889,389, filed on Feb. 12, 2007.

(51) Int. Cl. A23G 3/00; A23L 1/00

(52) U.S. Cl. 426/103; 426/613; 426/289

(57) ABSTRACT

Confectionery products comprising erythritol and methods of producing the confectionery products are provided. In a general embodiment, the present disclosure provides a confectionery product comprising erythritol, a fat and a gastrointestinal tolerant ingredient.

### BACKGROUND

The present disclosure relates generally to confectionery products. More specifically, the present disclosure relates to confectionery products comprising erythritol.

There are numerous types of confectionery products. Such confectionery products can include, for instance, hard or chewy candy. It is generally known that providing confectionery products having unique flavors and health benefits can lead to enhanced marketability with consumers.

Some sugarless chewy candies comprising polyols such as isomalt and sorbitol have a laxative effect. Chewy candies often are consumed fairly quickly and in a larger quantity than chewing gum. Therefore, the potential for gastrointestinal discomfort from consuming chewy candies is a concern.

### SUMMARY OF THE INVENTION

The present disclosure is directed to confectionery products comprising erythritol and methods of producing these confectionery products. In a general embodiment, the present disclosure provides a confectionery product comprising erythritol and a fat. In another embodiment, the present disclosure provides a confectionery product comprising erythritol, a fat and a gastrointestinal tolerant ingredient.

In an embodiment, the erythritol comprises from about 1% to about 70% by total weight of the confectionery product.

In an embodiment, the gastrointestinal tolerant ingredient comprises from about 30% to about 80% by total weight of the confectionery product.

In an embodiment, the gastrointestinal tolerant ingredient comprises polydextrose.

In an embodiment, the gastrointestinal tolerant ingredient comprises a dextrin (e.g. indigestible dextrin).

In an embodiment, the gastrointestinal tolerant ingredient comprises inulin, fructooligosaccharide, carboxymethyl cellulose, microcrystalline cellulose or combinations thereof.

In an embodiment, the confectionery product further comprises a crystallizing component.

In an embodiment, the erythritol comprises a crystallizing component of the confectionery product.

In an embodiment, the crystallizing component can be, for example, sugars, polyols or combination thereof. The sugars and polyols can be in any suitable form such as, for example, powders or syrups.

In an embodiment, the confectionery product comprises a hydrocolloid such as, for example, gelatin, gellan gum, xanthan gum, pectin, carrageenan, cellulose gum, gum arabic, modified starch or combinations thereof.

In an embodiment, the confectionery product can be, for example, nougat, pliable confectionery material, taffy, soft candy, chewy candy, caramel or combinations thereof.

In an embodiment, the confectionery product comprises another polyol such as, for example, sorbitol, maltitol, isomalt, mannitol, xylitol or combinations thereof.

In an embodiment, the polyol comprises from about 1% to about 25% by total weight of the confectionery product.

In an embodiment, the confectionery product comprises one or more ingredients such as, for example, malted products, sweeteners, flavors, colors, sensates, acids, medicaments, actives or combinations thereof.

In an embodiment, the confectionery product comprises a coating surrounding the chewy confectionery product.

In an embodiment, the coating comprises one or more ingredients such as, for example, malted products, sweeteners, flavors, colors, sensates, acids, medicaments, actives or combinations thereof.

In another embodiment, the present disclosure provides a method of making a confectionery product. The method comprises preparing a chewy candy mixture comprising erythritol, a fat and a gastrointestinal tolerant ingredient, and forming the chewy candy mixture to produce the confectionery product.

In an embodiment, the method further comprises applying a coating to the formed confectionery product.

In an embodiment, the coating comprises erythritol.

An advantage of the present disclosure is to provide an improved confectionery product providing health benefits.

Yet another advantage of the present disclosure is to provide an improved process for making confectionery products.

Additional features and advantages are described herein, and will be apparent from, the following Detailed Description.

### DETAILED DESCRIPTION

The present disclosure relates to confectionery products comprising erythritol and methods for producing the confectionery products. Erythritol does not cause tooth decay, and is absorbed by the body, therefore unlikely to cause gastric side effects unlike other sugarless sweeteners. Nevertheless, due to its high tendency to crystallize, erythritol tends to make a grainy product unless its crystallization is moderated or inhibited. Accordingly, the present disclosure provides confectionery products comprising erythritol and gastrointestinal tolerant ingredients that can also inhibit crystallization.

In a general embodiment, the present disclosure provides a confectionery product comprising erythritol, one or more fats and one or more gastrointestinal tolerant ingredients. The confectionery product of the present disclosure can be any suitable candy comprising a fat. For example, the confectionery product can comprise nougat, pliable confectionery material, taffy, soft candy, chewy candy, caramel or combinations thereof. In an embodiment, the fat can comprise from about 1% to about 20% by total weight of the confectionery product. In an alternative embodiment, the fat can comprise from about 5% to about 10% by total weight of the confectionery product.

In an embodiment, the erythritol can comprise from about 1% to about 70% by total weight of the confectionery product. In another embodiment, the erythritol can comprise from about 20% to about 60% by total weight of the confectionery product. In an alternative embodiment, the erythritol can comprise from about 40% to about 50% by total weight of the confectionery product.

The gastrointestinal tolerant ingredient can be any suitable ingredient that has a low or reduced laxation effect on a consumer's digestive system as understood by the skilled artisan. For example, the gastrointestinal tolerant ingredient is polydextrose or dextrin (e.g. indigestible dextrins). The dextrins can be made from wheat or corn. Indigestible dextrins are modified maltodextrins with very low reducing sugar content. Varieties are sold under the trade names of FIBERSOL® and NUTRIOSE®. FIBERSOL® is marketed by Fibersol America, a division of Matsutani Chemical Industry Co., Ltd of Hyogo-Pref., Japan. NUTRIOSE® is marketed by Roquette Freres of Lestrem, France. In an alternative embodiment, the gastrointestinal tolerant ingredient is inulin, fructooligosaccharide, carboxymethyl cellulose, microcrystalline cellulose or combinations thereof.

In an embodiment, the gastrointestinal tolerant ingredient comprises from about 30% to about 80% by total weight of the confectionery product. In another embodiment, the gastrointestinal tolerant ingredient comprises from about 40% to about 70% by total weight of the confectionery product.

As used herein, the term “fat” is synonymous with oils. The fat may include any suitable fats or oils such as, for example, canola oil, corn oil, soybean oil, peanut oil, cottonseed oil, peanut oil, coconut oil, safflower oil, sunflower oil, palm kernel oil, hydrogenated palm kernel oil, fractionated palm kernel oil, palm oil, tallow, hydrogenated tallow, hydrogenated and partially hydrogenated vegetable oils, cocoa butter or mixtures thereof. The confectionery product may also comprise any suitable emulsifiers. The emulsifiers may include glycerol monostearate, glycerol triacetate, lecithin, mono-, di- and triglycerides, acetylated monoglycerides, fatty acids (e.g. stearic, palmitic, oleic and linoleic acids) or combinations thereof.

In an embodiment, the confectionery product further comprises a crystallizing component. For example, the crystallizing component provides the confectionery product with a grainy texture. The erythritol (e.g. in granular or ground form) can comprise the crystallizing component of the confectionery product. In another embodiment, the crystallizing component can be, for example, sugars, polyols or combination thereof that are of sufficient particle size that they provide a grainy texture or mouthfeel to the confectionery product.

In another embodiment, the confectionery product can also comprise a hydrocolloid such as, for example, gelatin, gellan gum, xanthan gum, pectin, carrageenan, cellulose gum, gum arabic, modified starch or combinations thereof. In an alternative embodiment, the confectionery product can comprise another polyol such as, for example, sorbitol, maltitol, isomalt, mannitol, xylitol or combinations thereof. The polyols can be in any suitable form such as, for example, powders or syrups. The polyol can comprise from about 1% to about 25% by total weight of the confectionery product.

In an embodiment, the confectionery product comprises a coating surrounding the chewy confectionery product. The coating can initially be present as a liquid syrup which contains from about 30% to about 80% or 85% of the suitable coating ingredients, and from about 15% or 20% to about 70% of a solvent such as water. The coating syrups of the present disclosure may comprise erythritol or other polyol or non-polyol ingredients which are commonly used in sugar and sugarless coatings. The specific ingredients and their usage levels will vary greatly according to the intentions for the formulation. The coatings can be dried, for example, to form as soft or hard coating as desired.

In another embodiment, the present disclosure provides a method of making a confectionery product. The method comprises preparing a chewy candy mixture comprising erythritol, a fat and a gastrointestinal tolerant ingredient, and forming the chewy candy mixture to produce the confectionery product. For example, the chewy candy mixture can be formed by any suitable laminating, extruding or depositing processes. The confectionery products in embodiments of the present disclosure can be formed into any suitable size or shape such as, for example, a pellet, sphere, cube, cigarette, spiral, etc. The confectionery products can have any suitable thickness.

In an embodiment, the method further comprises applying a coating to the formed confectionery product. For example, the coating can comprise erythritol. In an embodiment, the erythritol may comprise from about 1% to about 70% by total weight of the confectionery product including the coating. In another embodiment, the erythritol can comprise from about 20% to about 60% by total weight of the confectionery product including the coating. In an alternative embodiment, the erythritol can comprise from about 40% to about 50% by total weight of the confectionery product including the coating.

Any suitable coating material (e.g. syrups) such as, for example, sugars, polyols or combinations thereof can be applied to the confectionery product (e.g. confectionery center) to form a crystalline or glassy coating around the confectionery product. It should be appreciated that the coatings can be applied to the confectionery products by any suitable coating method such as, for example, spraying, panning, etc. Optionally, flavors may be separately sprayed onto the pieces during the coating process to provide a flavored coating. Optionally, a final polishing coat may be applied to the pieces after the coatings have been applied. The polishing coat may use a wax, such as carnauba wax, or shellac. It may also include fillers such as talc and colors.

The chewy confectionery products of the present disclosure can also include confectionery particles or nonpareils within them. As laminated, extruded or deposited, the viscosity of the confectionery products can be such that the particles are heterogeneously distributed through processing.

It should be appreciated that one or more ingredients such malted products, flavors, sensates, colors (e.g. azo free colors), sweetener, acids, actives and medicaments (e.g. listed below) can go in the confectionery product and/or the coating surrounding the confectionery product. The ingredients can be added in a free form in any suitable amount. The ingredients can also be added in the form of encapsulation, compaction, granulation and agglomeration to provide, for example, protected and longer-lasting ingredient components such as flavors and sensates. It should also be appreciated that the chewy confectionery products and coatings can comprise any suitable number and combinations of the malted products, flavors, sweeteners (including high intensity), sensates, acids, actives and/or medicaments.

Sugar sweeteners generally may include saccharide-containing components commonly known in the confectionery art, including, but not limited to, sucrose, dextrose, maltose, dried invert sugar, fructose, levulose, tagatose, galactose, corn syrup solids, and the like, alone or in combination. Alternatively, sweeteners may include glycerin, fruit concentrates and fruit pastes.

Maltitol may be used as a sugarless sweetener. Additionally, sugarless sweeteners may include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners may also be used in combination with the above. Preferred high intensity sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener can vary greatly and will depend on such factors as potency of the sweetener, rate of release, desired sweetness of the product, level and type of flavor used and cost considerations.

The flavorant or flavor used in the confectionery products may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2 diol, and spearmint. Non-limiting examples of heating agents may include vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same. Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine and insulin.

### Examples

By way of example and not limitation, the following examples are illustrative of various embodiments of the present disclosure and further illustrate experimental testing conducted with the confectionery products in accordance with embodiments of the present disclosure.

### Example 1

Experiments were performed with chewy candies comprising erythritol, a non-laxative polyol, as a component of the sugarless chewy confectioneries. Additional sugar-free ingredients such as polydextrose and dextrin were also added to the confectionery products. Chewy candies comprising ingredients listed in Tables 1-7 were made. A coating syrup comprising erythritol, gum tahla (i.e. gum arabic), titanium dioxide and flavoring was applied to the confectionery to produce a coated confectionery product. The tastes and textures of the chewy candies were compared to that of a control chewy candy comprising isomalt (Table 8).

TABLE 1
Chewy Formulation A

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 225 |
| | Water | 85 |
| | Maltitol syrup | 65 |
| | Erythritol | 105 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol and maltitol syrup were added. “B” was cooked to 265° F. “C” was melted. After “B” reached 265° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 2
Chewy Formulation B

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 225 |
| | Water | 100 |
| | Erythritol | 155 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol was added. “B” was cooked to 265° F. “C” was melted. After “B” reached 265° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 3
Chewy Formulation C

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 175 |
| | Water | 70 |
| | Maltitol syrup | 130 |
| | Erythritol | 105 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol and maltitol syrup were added. “B” was cooked to 275° F. “C” was melted. After “B” reached 275° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 4
Chewy Formulation D

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 290 |
| | Water | 85 |
| | Maltitol syrup | 65 |
| | Erythritol | 40 |
| C | Fat | 29 |
| | Emulsifier | 1.25 |
| | Lecithin | 20 |
| D | Erythritol (finely ground) | 2.8 |
| | Sensate | 0.64 |
| | High intensity sweetener #1 | 0.27 |
| | High intensity sweetener #2 | 0.16 |
| | Color | |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol and maltitol syrup were added. “B” was cooked to 285° F. “C” was melted. After “B” reached 285° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 5
Chewy Formulation E

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 225 |
| | Water | 70 |
| | Maltitol syrup | 130 |
| | Erythritol | 40 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol and maltitol syrup were added. “B” was cooked to 310° F. “C” was melted. After “B” reached 310° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 6
Chewy Formulation F

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 290 |
| | Water | 85 |
| | Maltitol syrup | 65 |
| | Erythritol | 40 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol was added. “B” was cooked to 290° F. “C” was melted. After “B” reached 265° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 7
Chewy Formulation G

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Dextrin | 225 |
| | Water | 85 |
| | Maltitol syrup | 65 |
| | Erythritol | 105 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

The ingredients in “A” were combined, allowed to hydrate and then added to a mixing bowl. “B” was combined. The polydextrose was dissolved in water and then erythritol was added. “B” was cooked to 270° F. “C” was melted. After “B” reached 270° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

TABLE 8
Control Chewy Formulation

| Chewy | | |
|---|---|---|
| Confectionery | Ingredients | Amount (grams) |
| A | Gelatin (250 bloom) | 21.0 |
| | Water | 27.5 |
| B | Water | 42.5 |
| | Maltitol syrup | 256.5 |
| | Isomalt | 121.0 |
| C | Fat | 30.0 |
| | Emulsifier | 0.5 |
| | Lecithin | 1.0 |
| D | Isomalt | 44.0 |
| | Sensate | 2.5 |
| | High intensity sweetener #1 | 0.58 |
| | High intensity sweetener #2 | 0.25 |
| | Color | 0.15 |

Coating

| | Amount (grams) |
|---|---|
| Ingredients | (per 100 g centers) |
| Isomalt | 500 |
| Water | 175 |
| Gum tahla | 50 |
| High intensity sweetener | 0.28 |
| Titanium dioxide | 2.5 |

The ingredients in “A” were combined, allowed to hydrate and then added to a mixing bowl. “B” was combined and cooked to 285° F. “C” was melted. After “B” reached 285° F., it was added to the mixing bowl (“A” in bowl first). The gelatin was mixed in with a spoon. The combined mixtures was mixed on low speed until the mixture thickened. The mixture was then whipped for 2-5 minutes. “D” was combined with melted “C” and added slowly to the mixing bowl with low speed mixing to form the final chewy confectionery.

The aforementioned chewy formulations were based on using erythritol in the coating and in the center as the crystallizing component (in place of sugar in traditional chewies) plus non-crystallizing components dextrin and polydextrose. The chewy candies comprised between about 40 to about 54% erythritol by total weight. The formulations with high erythritol and polydextrose had a short and grainy texture. The addition of maltitol syrup to the erythritol/polydextrose center increased the chewiness (Chewy formula C). Chewy candy formulations with too little erythritol (Chewy formula D) and too much maltitol syrup (Chewy formula E) caused the chewy candy to stick to the teeth. According to internal sensory results, Chewy formula F was most similar in texture and chewiness to the control (Table 8).

Boiling temperature of the candy impacted the chewy candy's hardness and the duration of the chew. The higher the boiling temperature, the firmer the chew and the slower the dissolution. Bench scale sensory from Chewy formula A indicated that a slightly higher boiling point (e.g. 270-275° F.) gives a harder confection.

According to bench sensory testing, Chewy formula G provided a good reduced laxative chewy that uses erythritol and dextrin in the center. This product was also coated with erythritol (total erythritol approximately 45% by weight). The internal sensory descriptive indicated that Chewy formula G had a softer center than the control. Also, the erythritol coating was softer than the control isomalt coating. The experiments showed that the firmness of the center can be adjusted with different boiling points to match consumer preferences. Bench level sensory testing found the experimental, Chewy formula G, to be chewier and less grainy/short than the isomalt control.

All samples were coated with erythritol. Compared to an isomalt coating, erythritol is softer and more like a xylitol coating. Chewy formula F and Chewy formula G were chewier and less grainy than the control isomalt formula (Table 8). Including the coating, the erythritol content in Chewy formula F is about 40% and in Chewy formula F is about 45% (dry basis weight %).

In sum, the experiments showed that a variety of textures of chewy confectionery products comprising erythritol having different characteristics (e.g. ranging from grainy to smooth, less to more adhesive and chewy) was possible base on the formulations and processing conditions. The results showed that the resulting textures could be manipulated depending on the desired characteristics of the chewy confectionery product (e.g. where a more grainy or chewy quality is preferred). Erythritol, dextrin and polydextrose in the chewy candies produced reduced laxative, sugarless chewy candies that had good taste and textural properties. Of these three ingredients, erythritol has the highest gastrointestinal tolerance. Therefore, formulations with the greatest amount of erythritol should have the highest tolerance.

### Example 2

Chewy Confectionery Formulation

| Chewy | | |
|---|---|---|
| Confectionery | Ingredient | % ingredient |
| A | Maltitol syrup | 46.92 |
| | Erythritol | 22.13 |
| | Water | 7.77 |
| B | Water (final moisture) | 3.93 |
| | Gum arabic | 4.84 |
| | Fat | 5.48 |
| | Emulsifier | 0.091 |
| | Lecithin | 0.18 |
| | Isomalt PF | 8.04 |
| | Flavor | 0.45 |
| | Coloring | 0.027 |
| | High intensity sweetener #1 | 0.045 |
| | High intensity sweetener #2 | 0.036 |
| | Subtotal | 100 |
| | Finished with 5% moisture | |

The ingredients in “A” were combined and cooked to 300° F. “B” was combined with “A” and cooled to 230° F. The remaining ingredients were combined with the resulting mixture to form the final chewy confectionery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A confectionery product comprising:
erythritol;
a fat; and
a gastrointestinal tolerant ingredient.

2. The confectionery product of claim 1, wherein the erythritol comprises from about 1% to about 70% by total weight of the confectionery product.

3. The confectionery product of claim 1, wherein the gastrointestinal tolerant ingredient comprises from about 30% to about 80% by total weight of the confectionery product.

4. The confectionery product of claim 1, wherein the fat is selected from the group consisting of palm kernel oil, hydrogenated palm kernel oil, cocoa butter, fractionated palm kernel oil, hydrogenated and partially hydrogenated vegetable oil and combinations thereof.

5. (canceled)

6. The confectionery product of claim 1, wherein the gastrointestinal tolerant ingredient is selected from the group consisting of inulin, fructooligosaccharide, carboxymethyl cellulose, microcrystalline cellulose, dextrose, polydextrose and combinations thereof.

7. The confectionery product of claim 1 further comprising a crystallizing component.

8. (canceled)

9. The confectionery product of claim 7, wherein the crystallizing component is selected from the group consisting of sugars, polyols and combination thereof.

10. The confectionery product of claim 1, further comprising a hydrocolloid selected from the group consisting of gelatin, gellan gum, xanthan gum, pectin, carrageenan, cellulose gum, gum arabic, modified starch and combinations thereof.

11. The confectionery product of claim 1, wherein the confectionery product is selected from the group consisting of nougat, pliable confectionery material, taffy, soft candy, chewy candy, caramel and combinations thereof.

12. The confectionery product of claim 1, further comprising a polyol selected from the group consisting of sorbitol, maltitol, isomalt, mannitol, xylitol and combinations thereof.

13-14. (canceled)

15. The confectionery product of claim 1 further comprising a coating surrounding the chewy confectionery product.

16. (canceled)

17. A method of making a confectionery product, the method comprising:
preparing a chewy candy mixture comprising erythritol, a fat and a gastrointestinal tolerant ingredient; and
forming the chewy candy mixture to produce the confectionery product.

18. The method of claim 17, wherein the erythritol comprises from about 1% to about 70% by total weight of the confectionery product.

19. The method of claim 17, wherein the gastrointestinal tolerant ingredient comprises from about 30% to about 80% by total weight of the method.

20-21. (canceled)

22. The method of claim 17, wherein the gastrointestinal tolerant ingredient is selected from the group consisting of inulin, fructooligosaccharide, carboxymethyl cellulose, microcrystalline cellulose, dextrose, polydextrose and combinations thereof.

23. The method of claim 17 further comprising a crystallizing component.

24. The method of claim 23, wherein the erythritol comprises the crystallizing component of the confectionery product.

25. The method of claim 23, wherein the crystallizing component is selected from the group consisting of sugars, polyols and combination thereof.

26. The method of claim 17, further comprising applying a coating to the formed confectionery product.

27. The method of claim 26, wherein the coating comprises erythritol.
